(19) United States
(12) Patent Application Publication
(10) Pub. No.: US 2020/0380329 A1
(43) Pub. Date: Dec. 3, 2020

(54) RADIO FREQUENCY IDENTIFICATION DEVICE

(71) Applicants: Inventec (Pudong) Technology Corporation, Shanghai (CN); INVENTEC CORPORATION, Taipei (TW)

(72) Inventor: Yuan Sheng LIn, Taipei (TW)

(21) Appl. No.: 16/435,927

(22) Filed: Jun. 10, 2019

(30) Foreign Application Priority Data
May 28, 2019 (CN) 201910451656.8

(51) Int. Cl. G06K 19/07; G06K 19/077; H01Q 1/22; H01Q 5/335

(52) U.S. Cl. CPC G06K 19/0724; H01Q 5/335; H01Q 1/2225; G06K 19/07749

(57) ABSTRACT

A radio frequency identification device (RFID) includes an antenna, a first RFID chip and a second RFID chip. The antenna includes a first antenna pattern, a second antenna pattern and a shared emitting part, wherein the first antenna pattern and the second antenna pattern are connected to the shared emitting part respectively. The first RFID chip is electronically connected to the first antenna pattern and is adapted to transmit a first data using the first antenna pattern and the shared emitting part. The second RFID chip is electronically connected to the second antenna pattern and is adapted to transmit a second data using the second antenna pattern and the shared emitting part.

### CROSS-REFERENCE TO RELATED APPLICATIONS

This non-provisional application claims priority under 35 U.S.C. § 119(a) on Patent Application No(s). 201910451656.8 filed in China on May 28, 2019, the entire contents of which are hereby incorporated by reference.

### BACKGROUND

### 1. Technical Field

This disclosure relates to a radio frequency identification device, and more particularly to a radio frequency identification device that can be accessed to a plurality sets of data.

### 2. Related Art

The technique of radio frequency identification (RFID) is being developed rapidly in recent years. Specifically, the passive RFID device is often used in badges, card keys, metro cards or cargo management in logistics industry et cetera. Since RFID provides a mean of accessing data wirelessly, it can save the cost of labor and time.

RFID is a technique of transmitting data stored in its built-in chip wirelessly. RFID device and be categorized into active RFID device and passive RFID device, wherein the active RFID device has built-in batteries, which allows data transmission at all times and also serves a better transmission distance. On the other hand, the passive RFID device transmits data through firstly when RFID device enters the electromagnetic field of a reader, then the antenna circuits of both the reader and the RFID device are inductively coupled due to the change of magnetic field, and finally transmits the data stored in the RFID chip to the reader by generating an induced current in the RFID device. Therefore, the transmission distance is shorter in a passive RFID device. The advantages of a passive RFID device lie in its lower costs and portability because of the smaller size.

However, the current passive RFID device is limited to only access to one data at a time. Therefore, it's difficult to achieve the purpose of accessing a plurality of data simultaneously, which still causes some inconvenience during usage.

### SUMMARY

According to one or more embodiment of this disclosure, a RFID device includes an antenna having a first antenna pattern, a second antenna pattern and a shared emitting part, wherein the first antenna pattern and the second antenna pattern are connected to the shared emitting part respectively. The RFID device further includes a first RFID chip which is electronically connected to the first antenna pattern and is adapted to transmit a first data through the first antenna pattern and the shared emitting part. The RFID device further includes a second RFID chip which is electronically connected to the second antenna pattern and is adapted to transmit a second data through the second antenna pattern and the shared emitting part.

The above description and the below embodiments are used to demonstrate and explain the principles of present disclosure, and to provide a further explanation of the claims of present invention.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view of an embodiment of a RFID device.

FIG. 2 is a schematic view of an embodiment of another RFID device according to present disclosure.

FIG. 3 is a schematic view of an embodiment of yet another RFID device.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

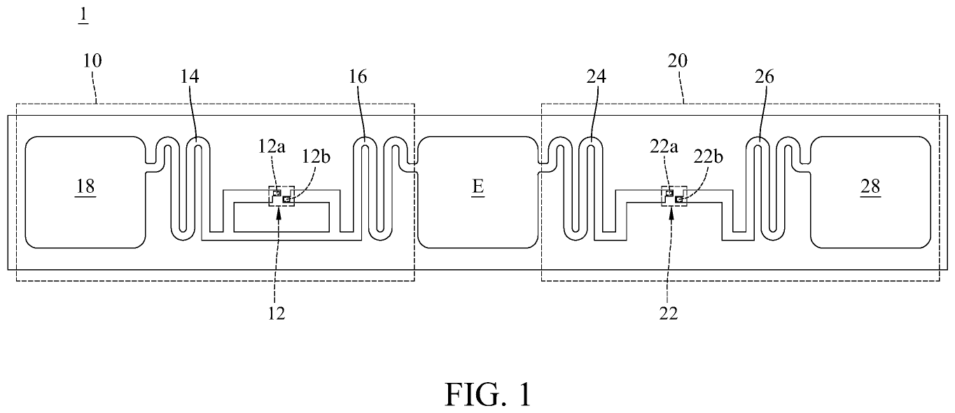

Please refer to FIG. 1, FIG. 1 is an embodiment of a radio frequency identification (RFID) device according to present disclosure. The RFID device 1 in present disclosure can be a passive electronic tag. The RFID device 1 includes an antenna which comprises of a first antenna pattern 10, a second antenna pattern 20 and a shared emitting part E. The RFID device 1 further includes a first RFID chip 12 and a second RFID chip 22, wherein the first antenna pattern 10 and the second antenna pattern 20 connect to the shared emitting part E respectively, and the first RFID chip 12 is adapted to transmit a first data through the first antenna pattern 10 and the shared emitting part E. The second RFID chip 22 is adapted to transmit a second data through the second antenna pattern 20 and the shared emitting part E.

Please continue referring to FIG. 1, the first antenna pattern 10 described above includes a first matching section 14, a second matching section 16 and a first emitting part 18. The first matching section 14 and the second matching section 16 are connected to a first pin 12a and a second pin 12b of the first RFID chip 12 respectively, and the first matching section 14 and the second matching section 16 can form another connecting section jointly (the segment located below the first RFID chip 12 as shown in FIG. 1) for impedance matching purpose. Specifically, the first matching section 14 and the second matching section 16 can be designed such that the path length between the first RFID chip 12 and the second RFID chip 22 is one-half of the wavelength. The one end of the first matching section 14 that's not connected to the first pin 12a is connected to the first emitting part 18; the one end of the second matching section 16 that's not connected to the second pin 12b is connected to the shared emitting part E. Similarly, the second antenna pattern 20 includes a third matching section 24, a fourth matching section 26 and a second emitting part 28. The third matching section 24 and the fourth matching section 26 connect to a third pin 22a and a fourth pin 22b of the second RFID chip 22 respectively, and the third matching section 24 and the fourth matching section 26 are separated from each other. The one end of the third matching section 24 that's not connected to the third pin 22a is connected to the shared emitting part E; the one end of the fourth matching section 26 that's not connected to the fourth pin 22b is connected to the second emitting part 28.

Please continue referring to FIG. 1, wherein the first RFID chip 12 and the second RFID chip 22 can have different impedance, and the four matching sections 14, 16, 24 and 26 which are matched to the two RFID chips 12 and 22 can have the same path length. Additionally, the first RFID chip 12 and the second RFID chip 22 can store the same data (meaning the first data can be the same as the second data), but preferably storing different data (meaning the first data is different from the second data) so as the RFID device 1 can have more data storage contents comparing to a general RFID device having only one RFID chip. The embodiment in FIG. 1 of present disclosure discloses that the reader can simultaneously access the data stored in the first RFID chip 12 and the second RFID chip 22 by connecting the first antenna pattern 10 and the second antenna pattern 20 in series through the shared emitting part E.

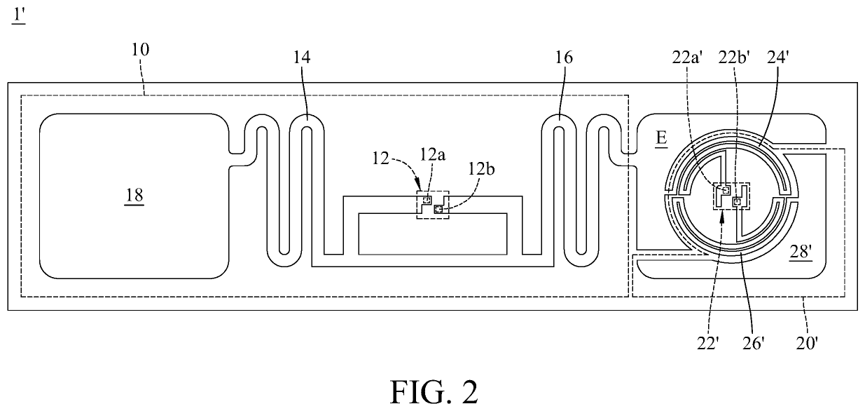

Please refer to FIG. 2, FIG. 2 is a schematic view of an embodiment of another RFID device according to present disclosure. The RFID device 1′ of the present embodiment has the same components as the RFID device 1 in FIG. 1. The difference between these two lies in the second antenna pattern 20′ in FIG. 2 being different from the second antenna pattern 20 in FIG. 1, which is the second antenna pattern 20′ and the shared emitting part E in FIG. 2 are configured in a configuration area, where the area of the configuration area is equal to or smaller than the area of the first emitting part 18. More specifically, setting the first RFID chip 12 and the second RFID chip 22′ with different impedance can result in the length between the third matching section 24′ and the fourth matching section 26′ being different from the length between the first matching section 14 and the second matching section 16, which further results in the first antenna pattern 10 and the second antenna pattern 20′ being different in size. Thereby, the embodiment of present disclosure can be achieved based on an antenna structure having only one RFID chip by having the majority of the antenna structure constitute the first antenna pattern 10 and the rest of the antenna structure (such as one of the two emitting parts in FIG. 1) replaced by the second antenna pattern 20′ and the shared emitting part E, which can still be adapted to configure a RFID device having a plurality of RFID chips.

Please continue referring to FIG. 2, by having the area of the configuration area of the second antenna pattern 20′ and the shared emitting part E equal to or smaller than the area of the first emitting part 18 as described above, a plurality of RFID chips can be disposed in the RFID device 1′ within at least the same configuration area as the antenna structure having only one RFID chip. And compares to the embodiment of FIG. 1, the present embodiment not only achieves the purpose of disposing and accessing a plurality of RFID chips simultaneously, but also efficiently lowers the size of the RFID device 1.

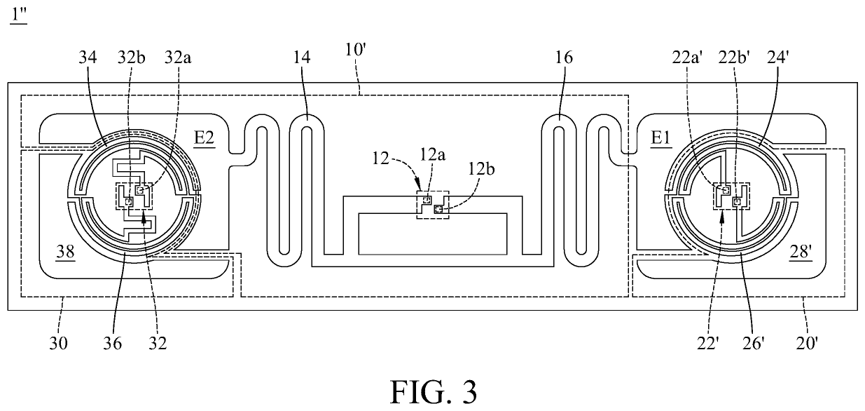

Please refer to FIG. 3, FIG. 3 is yet another embodiment of a RFID device 1″ according to present disclosure. The RFID device 1″ of the present embodiment not only shares the same components as the RFID device 1 and 1′ in FIG. 1 and FIG. 2, the RFID device 1″ further includes a third antenna pattern 30 and a third RFID chip 32, wherein the third antenna pattern 30 is electronically connected to the first antenna pattern 10′, and the third RFID chip 32 is electronically connected to the third antenna pattern 30. The third RFID chip 32 transmits a third data through the third antenna pattern 30 and a part of the first antenna pattern 10′. The third data can either be the same as the first and second data or different from the two. In the present embodiment, a first shared emitting part E1 is equivalent to the shared emitting part E in the previous embodiment, and a second shared emitting part E2 is approximate to the first emitting part 18 in the previous embodiment, meaning the part of the first antenna pattern 10′ described above is the second shared emitting part E2, and the third antenna pattern 30 is electronically connected to the second shared emitting part E2. More specifically, the third antenna pattern 30 is approximate to the configuration of the second antenna pattern 20′. The third antenna pattern 30 has a fifth matching section 34, a sixth matching section 36 and a third emitting part 38, wherein the fifth matching section 34 and the sixth matching section 36 are connected to a fifth pin 32a and a sixth pin 32 of the third RFID chip 32 respectively, and the fifth matching section 34 and the sixth matching section 36 are separated from each other. Specifically, the first matching section 14 and the second matching section 16 can be designed such that the path length between the first RFID chip 12 and the third RFID chip 32 is one-half of the wavelength. The one end that's not connected to the fifth pin 32a of the fifth matching section 34 is connected to the second shard emitting part E2, the one end that's not connected to the sixth pin 32b of the sixth matching section 36 is connected to the third emitting part 38.

Please continue referring to FIG. 3, by configuring the third antenna pattern 30 and the second shared emitting part E2 in the configuration area where the area is smaller than or equal to the configuration area of the first emitting part 18 of FIG. 2, the overall size of the RFID device 1″ may be at least the same when further disposing the third RFID chip 32 in the embodiment in FIG. 3. Therefore, the RFID device 1″ of the present embodiment can further expand the contents of stored data comparing to the previous embodiment without increasing the size of the RFID device 1″.

In the present disclosure, the matching sections are made of conductive materials and can realize the required antenna patterns for inductive coupling through various patterns. The working frequency of the matching sections can be determined based on the physical properties of the antenna patterns, for example, the length and width of antenna coils, the number of antenna coils and the material of the antenna, which however are not limited to the present invention.

The RFID device according to the present invention discloses by connecting the plurality of RFID chips in series, the RFID device won't be limited to loading RFID chips only with the same impedance, meaning the RFID device is operable as long as the impedance of the RFID chip and the corresponding antenna pattern can be matched to each other. Therefore, factors such as specifications, price and performance can be taken into consideration for each RFID chip when choosing one so as RFID chips from different manufactures or with specific impedance can be disposed on a single antenna. Besides, the RFID device according to present disclosure can additionally load the second and third RFID chips with the premise of not increasing the size of the RFID device, so as to achieve the purpose of accessing a plurality of RFID chips simultaneously.

The present disclosure has been disclosed above in the embodiments described above, however it is not intended to limit the present disclosure. It is within the scope of the present disclosure to be modified without deviating from the essence and scope of it. It is intended that the scope of the present disclosure is defined by the following claims and their equivalents.

What is claimed is:

1. A RFID device, comprising:
an antenna, having a first antenna pattern, a second antenna pattern and a shared emitting part, wherein the first antenna pattern and the second antenna pattern are connected to the shared emitting part respectively;
a first RFID chip, electronically connected to the first antenna pattern, wherein the first RFID chip is adapted to transmit a first data through the first antenna pattern and the shared emitting part; and
a second RFID chip, electronically connected to the second antenna pattern, wherein the second RFID chip is adapted to transmit a second data through the second antenna pattern and the shared emitting part.

2. The RFID device according to claim 1, wherein the first antenna pattern comprises a first emitting part, a first matching section and a second matching section, wherein the first matching section is connected to the first emitting part, the second matching section is connected to the shared emitting part, and two pins of the first RFID chip are connected to the first matching section and the second matching section respectively.

3. The RFID device according to claim 2, wherein the second antenna pattern comprises a second emitting part, a third matching section and a fourth matching section, wherein the third matching section is connected to the shared emitting part, the fourth matching section is connected to the second emitting part, the third matching section and the fourth matching section are separated from each other, and two pins of the second RFID chip are connected to the third matching section and the fourth matching section respectively.

4. The RFID device according to claim 1, wherein the RFID device further comprises a third antenna pattern and a third RFID chip, the third antenna pattern is electronically connected to the first antenna pattern, the third RFID chip is electronically connected to the third antenna pattern and is adapted to transmit a third data through the third antenna pattern and a part of the first antenna pattern.

5. The RFID device according to claim 2, wherein the RFID device further comprises a third antenna pattern and a third RFID chip, the shared emitting part is defined as a first shared emitting part, the first emitting part is defined as a second shared emitting part, the third antenna pattern is electronically connected to the second shared emitting part, and the third RFID chip is adapted to transmit a third data through the third antenna pattern and the second shared emitting part.

6. The RFID device according to claim 5, wherein the third antenna pattern comprises a third emitting part, a fifth matching section and a sixth matching section, wherein the fifth matching section is connected to the first emitting part, the sixth matching section is connected to the third emitting part, the fifth matching section and the sixth matching section are separated from each other, and two pins of the third RFID chip are connected to the fifth matching section and the sixth matching section respectively.

7. The RFID device according to claim 1, wherein the first RFID chip and the second RFID chip have different impedance.

8. The RFID device according to claim 1, wherein the first data is different from the second data.

9. The RFID device according to claim 1, wherein the second antenna pattern and the shared emitting part are disposed in a configuration area, and an area of the configuration area is smaller than or equal to an area of the first emitting part.
